(19) United States
(12) Patent Application Publication
(10) Pub. No.: US 2026/0143362 A1
(43) Pub. Date: May 21, 2026

(54) Radio Access Network Artificial Intelligence Assistant

(71) Applicant: T-Mobile Innovations LLC, Overland Park, KS (US)

(72) Inventors: Matthew D. KURTZ, Apopka, FL (US); Shane A. LOBO, Ponte Vedra, FL (US); Robert D. LUMPKINS, Marietta, GA (US); Matthew E. MARISCAL, Tallahassee, FL (US); Christopher Charles POIRIER, Titusville, FL (US); Paul Andrew SHINHOLSTER, JR., Orlando, FL (US)

(21) Appl. No.: 18/952,813

(22) Filed: Nov. 19, 2024

(51) Int. Cl. H04W 24/04; G06F 40/166; G06F 40/40; H04L 41/16

(52) U.S. Cl. CPC H04W 24/04; G06F 40/166; G06F 40/40; H04L 41/16

(57) ABSTRACT

A method to automate network management and maintenance operations in a radio access network (RAN) is provided. The method includes receiving a request for information associated with a network condition in a RAN; selecting, based on contextual information associated with the request, a function from functions associated with RAN operational data retrieval; generating, based on the request and/or the contextual information, prompts; providing, to a large language model (LLM), the request, a reference to the selected function, and the prompts; receiving, from the LLM, the selected function; invoking the received selected function to retrieve, from a datastore, RAN operational data; initiating the LLM to generate a response to the request based on the retrieved RAN operational data and the prompts; receiving, from the LLM, the response including information associated with a network issue in the RAN; and initiating an action to report and/or an action to resolve the network issue.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Communication network operators build systems and tools to monitor their networks, to identify network elements (NEs) that need maintenance, to assign maintenance tasks to personnel, and to fix NEs. Operational support systems (OSSs) may be provided by vendors of NEs to monitor and maintain their products. When trouble occurs in NEs, the OSS and/or the NEs may generate an alarm notification. An incident reporting system may be provided by the network operator to track incident reports which may be assigned to employees to resolve one or more pending alarms. A network operation center (NOC) may provide a variety of workstations and tools for NOC personnel to monitor alarms, close incident reports, and maintain the network as a whole. Operating and maintaining a nationwide communication network including tens of thousands of cell sites and other NEs can be complicated.

### SUMMARY

In an embodiment, a method to automate network management and maintenance operations in a radio access network (RAN), the method comprising receiving, by an artificial intelligence (AI) assistant application executing on a computer system, from a network operations center (NOC) dashboard system, a request for information associated with a network condition in a RAN; selecting, by the AI assistant application, based on contextual information associated with the request, a function from a plurality of functions associated with RAN operational data retrieval; generating, by the AI assistant application, based on at least one of the request or the contextual information, one or more prompts; providing, by the AI assistant application, to a large language model (LLM), the request, a callback function referencing the selected function, and the one or more prompts; receiving, by the AI assistant application, from the LLM, the callback function; invoking, by the AI assistant application, the received callback function to retrieve, from a datastore, RAN operational data; initiating, by the AI assistant application, the LLM to generate a response to the request based on the retrieved RAN operational data and the one or more prompts; receiving, by the AI assistant application from the LLM, the response including information associated with a network issue in the RAN; and initiating, by the AI assistant application, at least one of an action to report or an action to resolve the network issue based on the response.

In another embodiment, a method implemented in a network system to automatically retrieve and provide information associated with network conditions in a particular context of a radio access network (RAN) based on a source of a question using artificial intelligence (AI) assistance, the method comprising receiving, by an AI assistant application executing on a computer system, from a network operations center (NOC) dashboard system via a natural language user interface, a question associated with a network condition in a RAN, wherein the question is in natural language; determining, by the AI assistant application, contextual information associated with the question based on a particular module of a network management application that initiated the question, wherein the contextual information is associated with at least one of a national context, a service segment context, a cell site context, or an incident context; selecting, by the AI assistant application, based on the contextual information, a function from a plurality of functions associated with RAN operational data retrieval; generating, by the AI assistant application, based on at least one of the question or the contextual information, one or more prompts; providing, by the AI assistant application, to a large language model (LLM), the question, a callback function referencing the selected function, and the one or more prompts; receiving, by the AI assistant application, from the LLM, the callback function; invoking, by the AI assistant application, the received callback function to retrieve RAN operational data from a datastore; initiating, by the AI assistant application, the LLM to generate, using the retrieved RAN operational data and the one or more prompts, a response to the question; receiving, by the AI assistant application, from the LLM, the response in natural language and comprising information associated with at least one of a network unavailability, a service segment unavailability, a cell site unavailability, or incidents in the RAN; and transmitting, by the AI assistant application, the response to the NOC dashboard system.

In yet another embodiment, a system comprising a network management dashboard system to provide a display of information associated with network conditions in the telecommunications network; and provide a user interface (UI) to receive a request associated with network management in the telecommunications network; a datastore to store network operational data associated with the telecommunications network; a computer system comprising; at least one processor; at least one non-transitory memory; and an artificial intelligence (AI) assistant application comprising instructions stored in the at least one non-transitory memory, which when executed by the at least one processor, causes the AI assistant application to receive, from the network management dashboard system, the request associated with network management in the telecommunication network; determine contextual information based on the request; initiate, based on contextual information, a clickable button to be populated in the UI for activating an action to resolve an issue in the telecommunication network; select, based on the contextual information and an activation of the clickable button, a function from a plurality of data retrieval functions; generate, based on at least one of the request or the contextual information, one or more prompts; provide, to a large language model (LLM), the request, the one or more prompts, and an indication of the selected function; receive, from the LLM, a request to invoke the selected function; execute the selected function to retrieve the network operational data from the datastore; initiate the LLM to generate a response to the request based on the retrieved network operational data and the one or more prompts; receive, from the LLM, the response including information associated with at least one of a network unavailability, a service segment unavailability, a cell site unavailability, or incidents in the telecommunication network; and initiate, based on the response, an action to resolve the issue in the telecommunication network.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, where like reference numerals represent like parts.

FIG. 1 is a block diagram of a network system according to an embodiment of the disclosure.

FIG. 2 is a signaling diagram illustrating a method of performing network management and maintenance operations using artificial intelligence (AI) assistance according to an embodiment of the disclosure.

FIG. 3 is a signaling diagram illustrating a method of summarizing a network operational data log using AI assistance according to an embodiment of the disclosure.

FIG. 4 illustrates an example scenario of using a conversation stack for AI assisted network management and maintenance according to an embodiment of the disclosure.

FIG. 5 is a flow chart of a method according to an embodiment of the disclosure.

FIG. 6 is a flow chart of another method according to an embodiment of the disclosure.

FIG. 7A and FIG. 7B are block diagrams of a fifth generation (5G) network according to an embodiment of the disclosure.

FIG. 8 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

In a telecommunication network, a network operations center (NOC) for radio, transport, and field operations may rely on a certain application (e.g., in the form of a dashboard) for troubleshooting, root cause analysis, and executing break-fix actions in the network. Examples of radio operations may include, but are not limited to, radio access network (RAN) operations that connect user devices (e.g., mobile devices) to other parts of a network via radio connections, frequency management, signal optimization, base station management, and radio planning and optimization. A RAN may include a plurality of cell sites (e.g., base stations, towers, antennas) and other radio infrastructure. The radio operations may be configured and optimized to increase network coverage, capacity, and performance. Examples of transport operations may include, but are not limited to, backhaul operations that connect a RAN to a core network that provides various services to users who are connected by the RAN, network infrastructure management operations, and/or quality of service (QoS) provisioning operations. Examples of field operations may include, but are not limited to, installations and maintenance of network elements (NEs), such as base stations, antennas, and/or fiber transmission lines in the field, troubleshooting and repairing NEs in the field, and upgrading NEs in the field. The NOC may track and/or log a history of these radio, transport, and/or field operations. Accordingly, the NOC may have access to a wealth of operational data across the network.

A user (e.g., NOC personnel) may navigate different areas of the dashboard application to obtain information for troubleshooting. For instance, when a user attempts to solve an issue in the network, the user may access certain network data (e.g., depending on the nature of the issue). In an example, the user may access recent events, which may include recent incidents (or detected problems) in a specific cell site. Additionally or alternatively, the user may access current site conditions and equipment statuses, which may provide real-time insights into the current states of cell sites and/or equipment. Additionally or alternatively, the user may access cell site inventory (e.g., equipment, NEs, and respective connections). Additionally or alternatively, the user may access historical data related to cell site conditions, symptoms, and past resolutions.

As discussed above, a network can include tens of thousands of cell sites and other NEs. Identifying a root cause and/or solving a network issue can be complex and time-consuming. For instance, a user may typically research multiple areas within the dashboard application to analyze, root cause, and solve a network issue. While the dashboard application can provide various network operational data that can assist troubleshooting, root cause analysis, and/or fixing network issues, end users (e.g., NOC personnel) of the dashboard application can have varying skills, and thus different users may or may not arrive at the same or correct solutions. Further, some users may not thoroughly investigate a problem, leading to incorrect conclusions. Other users may lack time to explore all the resources (e.g., megabytes or gigabytes of network data) available within the NOC system. In some cases, certain incident reports or tickets may be opened (upon detecting issues and/or alarms in the network) and closed without anyone knowing the actions that were taken and/or the reasons those incident reports or tickets were being closed. Furthermore, various areas of the dashboard application may be upgraded from time-to-time, and thus users may have to spend time to get accustomed to (or trained on) the newer version of the dashboard application. Accordingly, it may be desirable to have a streamlined process that is more accurate, consistent, and efficient for network management and maintenance.

The present disclosure provides a technical solution to the aforementioned technical problems in the technical field of network management and maintenance to provide efficient, accurate, consistent, and streamlined techniques for network management and maintenance using artificial intelligence (AI). For instance, an NOC may utilize an AI assistant to bridge the gap between complex data collected from a network and user-friendly insights into the health of the network. Some examples of network health information may include, but are not limited to, current network conditions, a network unavailability, a market segment or service segment unavailability (e.g., related to fifth generation (5G), long-term evolution (LTE), prepaid service brands, post-paid service brands, and/or Internet of Things (IoT) service brands, etc.), a cell site unavailability, a leading issue in the network, a next leading issue in the network, high-priority issues in a particular area (e.g., a particular country, a particular state, a particular county, a particular city, etc.) reported incidents, and/or resolved incidents. The NOC may provide a dashboard system with a natural language user interface (“chat interface”) for NOC personnel to communicate (“chat” or converse) with the AI assistant using natural language (e.g., spoken or written human language). That is, NOC personnel may ask questions using human spoken language, and the AI assistant may generate human spoken language-like responses to the questions. The AI assistant may bundle a question with a corresponding function to access data collected from the network and provide the bundled question and data access function to one or more large-language models (LLMs) for generating a response to the question. In some embodiments, the AI assistant may provide a summary of the network conditions, analysis of the network conditions, and/or recommended actions in the network. In some embodiments, the AI assistant may automate operations to report and/or resolve identified issues in the network.

According to an embodiment of the present disclosure, a telecommunication network system may include a network management system, an AI assistant system, LLMs, and a datastore. The network management system may be referred to as an NOC dashboard system. The AI assistant system may be referred to as a generative pre-trained transformer (GPT) gateway. The datastore may store network operational data related to operations in a RAN of the network system. In some instances, the network operational data may also include information associated with a core network of the network system that connects the RAN to other data networks (e.g., the Internet). An AI assistant application may be implemented in the AI assistant system (e.g., a computer system) to provide insights into the health (e.g., network conditions) of the RAN and/or the core network and/or automate network management and/or maintenance operations. A dashboard application with a natural language user interface and a graphical user interface (GUI) may be implemented in the network management system. The natural language user interface and the GUI may interact with users (e.g., NOC personnel) for troubleshooting, analyzing, and resolving issues in the network. The dashboard application may receive a natural language question (e.g., a first question) from a user via the natural language user interface. The question may be related to an inquiry about a network condition in the network system (e.g., a RAN of the network system). Examples of the question may include, but are not limited to, “what is the health of the network?”, “what is the leading issue in the network?”, “what is the next leading issue in the network?”, “what is the high-priority issues in this particular country (e.g., U.S, Canada, Mexico, etc.)?”, “what is the high-priority issues in this particular area (e.g., a particular state, a particular county, a particular city, etc.) ?”, “what tool(s) can I use to diagnose a network issue?”, “what is the network unavailability?”, “what is the market or service segment unavailability?”, “what is a cell site unavailability?”, and “can you summarize what is going on in the network?”.

The dashboard application may communicate with the AI assistant application to obtain a response to the question. For instance, the dashboard application may send the question to the AI assistant application. Upon receiving the question, the AI assistant application may determine contextual information associated with the question. The contextual information may include a national context, a cell site context, a market or service segment context, or an incident context. The national context may refer to nationwide network operations and/or performance in the network system. The cell site context may refer to operations and/or performance related to a specific cell site of the network system. The market or service segment context may refer to network operations and/or performance of a certain market or service segment in the network system. The incident context may refer to operations related to opened incident tickets and/or reports of resolved incidents (e.g., including symptoms, root causes, and resolutions) in the network. In some instances, the determination of the contextual information associated with the question may be based on a part or a module of the dashboard application in which the question is initiated. As an example, if the question is initiated from a part (e.g., a software module) of the application related to nationwide operations, the AI assistant application may determine that the question is related to a national context. As another example, if the question is initiated from a part of the application related to operations of a specific site, the AI assistant application may determine that the question is related to a site context. As yet another example, if the question is initiated from a part of the application related to operations of a specific market or service segment, the AI assistant application may determine that the question is related to a market or service segment context. As a further example, if the question is initiated from a part of the application related to incident tickets and/or incident reports, the AI assistant application may determine that the question is related to an incident context. In some instances, the determination of the contextual information associated with the question may be based on a role associated with a user account in which the question is initiated. For instance, different NOC personnel may be responsible for maintaining different areas of network operations (e.g., national network operations, market or service segment specific operations, etc.), and thus a user account of the NOC personnel that initiated the question may indicate the area or context associated with the question.

After determining the contextual information associated with the question, the AI assistant application may select a function from a pool of data retrieval functions based on the contextual information. Different data retrieval functions may retrieve different types of data from the datastore. For instance, the pool of data retrieval functions may include a first function to retrieve data associated with nationwide network operations, performance, and/or issues (e.g., detected failures or fixes for a certain operation across the country), a second function to retrieve data associated with a specific site (e.g., including detected failures or fixes for operations and/or performance related to the specific site), a third function to retrieve data associated with a specific market or service segment (e.g., including detected failures or fixes for operations and/or performance related to 5G but not LTE), and a fourth function to retrieve data associated with incident tickets that are opened, in-progress, and/or closed and/or related incident reports. In an embodiment, the datastore may be a vector database, and the data retrieval functions may utilize a retrieval augmentation generation (RAG) process to retrieve respective data. In an embodiment, the datastore may be a graph database, where data are stored as nodes connected by edges representing relations among respective data.

The AI assistant application may utilize one or more LLMs to generate a response to the question. To guide an LLM in generating the response, the AI assistant application may generate prompts based on the question and/or the contextual information. A prompt can be a statement including a textual description of at least some of the contextual information. A prompt can also operate as a guardrail to guide the LLM to limit the scope of the response to be within RAN related information. After generating the prompts, the AI assistant application may provide the question, a callback function referencing the selected function, and the prompts to the LLM (e.g., via an application programming interface (API) call). The callback function indicates to the LLM that additional data can be provided to the LLM for generating the response to the question, if needed. For instance, the LLM may process the question and the prompts and determine that additional data is needed. Thus, the LLM may send, and the AI assistant application may receive the callback function. Upon receiving the callback function, the AI assistant application may invoke the callback function (i.e., the selected function) to retrieve network operational data from the datastore. The AI assistant application may provide the retrieved network operational data to the LLM and initiate the LLM to generate a response for the question using the retrieved network operational data and the prompts. Subsequently, the AI assistant application may receive, from the LLM, the response including information associated with at least one of a network unavailability, a market or service segment unavailability, a cell site unavailability, or incidents in the network. The AI assistant application may provide the received response to the dashboard application (e.g., for display via the natural language user interface). In an embodiment, the AI assistant application may select the LLM from a pool of LLMs based on the received first question and/or the generated prompts. Each LLM in the pool may have different model attributes and may be suitable for generating different types of responses. For example, one LLM may be proficient in generating summaries and another LLM may be proficient in analyzing data and providing reasonings and/or suggesting corrective actions in the network.

In an embodiment, the network operational data retrieved from the datastore may include a network operational and/or maintenance data log (which may be referred to as a worklog). In an example, the worklog may include a history of site conditions, incidents, and/or past resolutions in the RAN. In general, the worklog may include a record of activities performed in the RAN to diagnose and/or maintain operations of the RAN. In such an embodiment, as part of initiating the LLM to generate the response to the question, the AI assistant application may request the LLM to generate a summary of the worklog based on the question and the prompts. As an example, NOC personnel may be tasked or assigned with a certain incident report and may desire to obtain a summary of the worklog (e.g., what are the recent incidents and what actions were taken to fix those incidents) prior to digging deeper into the assigned incident report. In an embodiment, as part of requesting the LLM to generate the summary of the worklog, the AI assistant application may determine whether the length of the worklog exceeds a certain threshold (e.g., about 4000 characters). If the length of the worklog exceeds the certain threshold, the AI assistant application may partition the worklog into multiple portions. In an example, the threshold may be based on a capability of the LLM or a limitation imposed by a service subscription of the LLM. After partitioning the worklog into portions, the AI assistant application may request the LLM to summarize each portion based on the question and the prompts. In response, the AI assistant application may receive a sub-summary for each portion from the LLM. The AI assistant application may provide all the received sub-summaries (for respective portions of the worklog) to the LLM and request the LLM to generate a final summary based on the question and/or the prompts. The LLM may process the sub-summaries based on the question and/or the prompts. The LLM may send, and the AI assistant application may receive the final summary. Subsequently, the AI assistant application may provide the final summary to the dashboard application (e.g., for display via the natural language user interface).

In some cases, the AI assistant application may receive repeating questions and/or partially overlapping questions. The processing of the LLM can be computationally complex and/or may have an associated cost (e.g., in terms of computational resources, memory resources, and/or service or subscription fee for using the LLM). As such, to reduce computational complexity and cost, the AI assistant application may store (or cache) responses or summaries received from the LLM in cache memory and may reuse (retrieve) at least some of those responses and/or summaries for a subsequent question that at least partially overlaps with a previous question. For instance, the AI assistant application may store the response to the first question in the cache memory. The AI assistant application may subsequently receive a second natural language question from the network management system via the natural language user interface. The AI assistant application may provide the network management system with a response to the second question using at least a portion of the response (to the first question) stored in the cache based on a determination that the portion of the response stored in the cache is relevant to the second question. That is, the LLM can be used efficiently to generate a response (portion) or a summary (portion) only for new data. In some instances, the AI assistant application may validate the cache memory (e.g., to ensure that the responses in the cache memory is current and valid) prior to using the response stored in the cache to construct the response for the second question.

In an embodiment, the AI assistant application may determine recommended follow-up questions that a user may ask after receiving an initial question from the user. For instance, the first question received from the network management system may be based on the recommended follow-up questions. For instance, the first question may be one of the recommended follow-up questions or a variant of one of the recommended follow-up questions. As an example, the initial question may be “what is the leading issue in the network?”, a recommended follow-up question may be “what is the next leading issue in the network?”, and the first question may be “what are the next top 3 leading issues in the network?”. Some examples of leading issues in a RAN may include a high retransmission rate, a high bit-error-rate (BER), a high packet error rate (PER), and/or connection failures. As another example, the initial question may be “what is the leading issue in the network?”, a recommended follow-up question may be “what is the root cause of the leading issue in the network?”, and the first question may be “what is the root cause of the leading issue in the network?”. A leading issue may be a technical issue that occurs most commonly in the RAN or a technical issue that impacts the greatest number of cells across the RAN. NOC technicians may, for example, wish to know the leading issues in the RAN to prioritize fixing or otherwise mitigating the first leading issue first, then addressing the second leading issue second, and so forth.

In some cases, maintaining a conversation stack to store information related to a particular conversation (which may include multiple questions and responses) can assist the LLM in providing more informational or relevant responses. For instance, the AI assistant application may store the first question, the callback function referencing the selected function, and the prompts in a conversation stack. The AI assistant application may provide the conversation stack to the LLM when initiating the LLM to generate a response for the first question. Further, the AI assistant application may store the callback request from the LLM and the retrieved network operational data to the conversation stack. Upon receiving a second question from the network management system, the AI assistant application may determine contextual information associated with the second question, select a second function from the pool of data retrieval functions, generate second prompts based on the second contextual information and/or the second question. The AI assistant application may add the second question, second selected function, and the second prompts to the conversation stack and provide the updated conversation stack to the LLM. The AI assistant application may initiate the LLM to generate a response to the second question based on the updated conversation stack. As an example, the first question may be “what is the leading issue in the network?”, and the second question may be “what is the next leading issue in the network?”. By providing the LLM with the updated conversation stack including exchanges (between the LLM and the AI assistant application) related to the first question, the LLM can have more informational context when generating the response to the second question.

To further enhance user experience, the dashboard application may provide various GUI functions (e.g., clickable buttons) that a user (e.g., NOC personnel) may trigger to perform certain network management and maintenance operations (e.g., common and/or frequently operations). Referring to the above example of generating a summary for a worklog, the GUI may include a button, e.g., “Generate worklog summary”, that the user may click and the dashboard application may transmit a worklog summary generation request to the AI assistant application, and the AI assistant application may generate a worklog summary as discussed above. In some further embodiments, the dashboard application may accept a voice command from a user instead of a question in texts. For instance, the user may ask about a network condition in the RAN via a voice command, and the dashboard application may communicate with the AI assistant application to provide a response to the user as discussed above. The network management system may include a speech-text conversion engine to convert the voice command to text and to convert the response (in text) back to speech.

In a further embodiment, AI assistant application can initiate (or trigger) a certain GUI function (e.g., a clickable button) to be populated based on a request input by a user (or an operator) in the chat interface of the NOC dashboard system. For instance, the user may enter a request or question: “How can I fix a problem Y?”, and the AI assistant application can cause the GUI of the NOC dashboard system to generate a clickable button (in real-time) that can be activated to resolve the problem Y. That is, the AI assistant application may utilize functions (or tools) and data available to the AI assistant application and the assistance of an LLM to perform root cause analysis on the issue and determine an action to resolve the issue. To that end, the AI assistant application may determine the contextual information based on the request. The AI assistant application may initiate, based on the contextual information, a clickable button to be populated in the UI for activating an action to resolve an issue in the telecommunication network. The AI assistant application may select, based on the contextual information and an activation of the clickable button, a function from a plurality of data retrieval functions. The AI assistant application may generate, based on at least one of the request or the contextual information, or the one or more prompts. The AI assistant application may provide, to an LLM, the request, the one or more prompts, and an indication of the selected function. The AI assistant application may receive, from the LLM, a request to invoke the selected function. The AI assistant application may execute the selected function to retrieve the network operational data from the datastore. The AI assistant application may initiate the LLM to generate a response to the request based on the retrieved network operational data and the one or more prompts. The AI assistant application may receive, from the LLM, the response including information associated with the network condition in the telecommunication network. The AI assistant application may initiate, based on the response, an action to resolve the issue in the telecommunication network.

Providing an AI assistant and LLM(s) to access network operation data across a network (e.g., a RAN and a respective core network) stored at an NOC center can enable the AI assistant and the LLM(s) to draw insights or conclusions into the health of the network and/or automate certain network management and/or maintenance operations. Leveraging the AI assistant and LLM(s) to provide insights into the health of the network instead of having NOC personnel to perform troubleshoot, root cause analysis, and break-fix actions can streamline the network management and maintenance process, and thus can save time and allow novice and experienced users (NOC personnel) to efficiently perform network management and maintenance operations. For instance, using human effort to troubleshoot a certain network issue may take more than 10 minutes, whereas leveraging the AI assistant to perform the same task may take less than 2 minutes. Providing a chat-like interface can allow NOC personnel to interact naturally with the AI assistant to quickly access relevant information and draw informed conclusions about the health of the network. Selecting a particular data retrieval function from a pool of data retrieval functions based on a context associated with a question can reduce the amount of data to be processed by the LLM(s), and thus can enable the AI assistant and LLM(s) to provide a response to a question in real-time. Storing the network operational data in a datastore using a vector database format and using a retrieval-augment generation (RAG) process as part of a data retrieval enables efficient search in the datastore. RAG is a technique for enhancing the accuracy and reliability of a generative AI model with facts fetched from external sources (e.g., an authoritative knowledge base outside of the training data sources used for training the AI model). Selecting a particular LLM from a pool of LLMs of different model attributes can reduce computational complexity and/or costs. Further, caching exchanges (e.g., questions, responses, data retrieval functions, retrieved data, etc.) between a user and the AI assistant and reusing the cached responses (or portions of the responses) for a subsequent user question can reduce computational complexity and/or costs. Maintaining a conversation stack to store information related to a particular conversation (which may include multiple questions and responses) can assist an LLM in providing more informational or relevant responses. Providing GUI functions for frequently and/or commonly triggered network management and/or maintenance operations can ease NOC personnel in performing network management and maintenance operations. In general, there are a vast amount of collected network data and tools (e.g., network management, troubleshooting tools) available to assist with network management and maintenance operations, the AI assistant can help to locate the right tools, to find network issues, to root cause those issues, and/or to resolve those issues. While the present disclosure is discussed in the context of using AI assistance to diagnose and/or correcting issues in a RAN and/or a respective core network, similar mechanisms can be applied to bridge the gap between network data of any network to provide user-friendly insights into the health of the network.

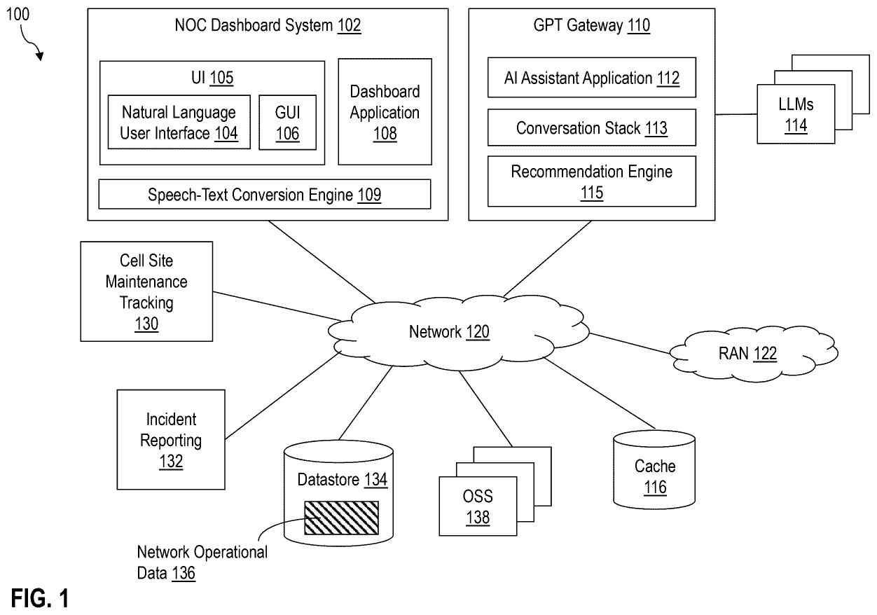

Turning now to FIG. 1, a network system 100 is described. In an embodiment, the network system 100 comprises an NOC dashboard system 102, a GPT gateway 110, a plurality of LLMs 114, a cache 116, a network 120, a cell site maintenance tracking system 130, an incident reporting system 132, and a datastore 134, and a plurality of operational support systems (OSSs) 138.

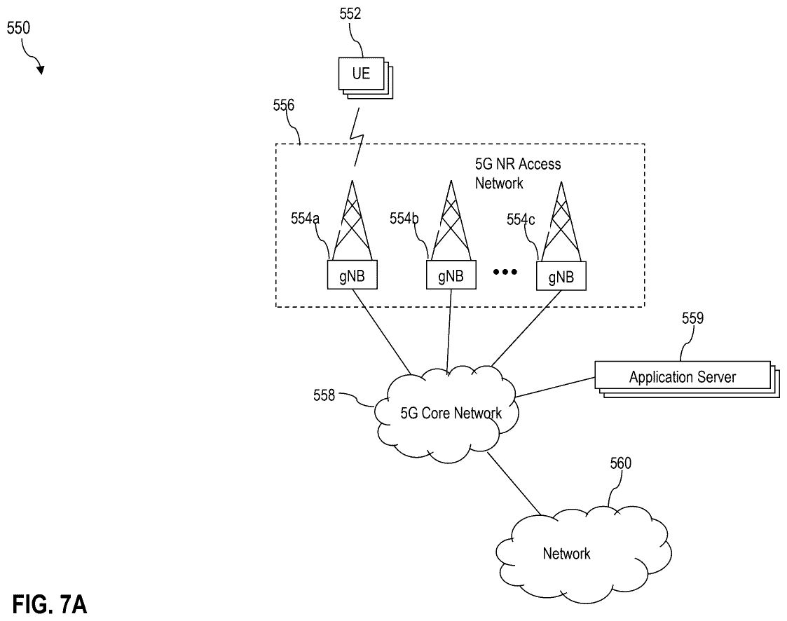

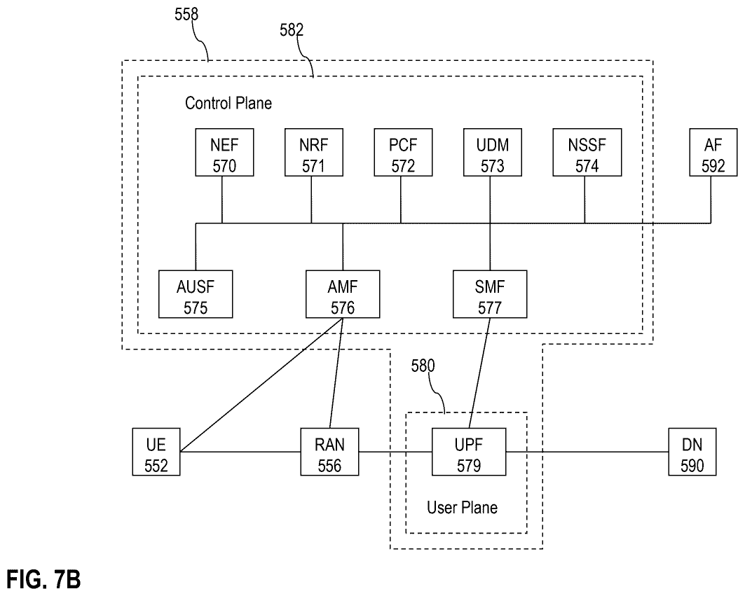

The RAN 122 comprises a plurality of cell sites and backhaul equipment. In an embodiment, the RAN 122 comprises tens of thousands or even hundreds of thousands of cell sites. The cell sites may comprise electronic equipment and radio equipment including antennas. The cell sites may be associated with towers or buildings on which the antennas may be mounted. The cell sites may comprise a cell site router that provides a backhaul link from the cell sites to the network 120. The cell sites may provide wireless links to user equipment (e.g., mobile phones, smart phones, personal digital assistants, laptop computers, tablet computers, notebook computers, wearable computers, headset computers) according to a 5G, a LTE, code division multiple access (CDMA), or a global system for mobile communications (GSM) telecommunication protocol. An example of a 5G RAN is discussed below with reference to FIGS. 7A and 7B. In an embodiment, the OSSs 138 comprises tens or even hundreds of OSSs. The network 120 comprises one or more public networks, one or more private networks, or a combination thereof. The RAN 122 may from some points of view be considered to be part of the network 120 but is illustrated separately in FIG. 1 to promote improved description of the system 100.

The cell site maintenance tracking system 130 is a system implemented by one or more computers. Computers are discussed further hereinafter. The cell site maintenance tracking system 130 is used to track maintenance activities on NEs (e.g., cell site equipment, routers, gateways, and other network equipment). In some instances, the cell site maintenance tracking system 130 may track and store the maintenance activities in the datastore 134. An NE may generally include error detection functionalities and may trigger an alarm upon detecting an error at the NE. NE errors may generally be related to and/or resulting in connectivity issues and can be caused by hardware and/or software issues. The specific types of NE errors may vary depending on the NE type (e.g., cell tower, backhaul equipment, routers, etc.). In an example, alarms are flowed up from NEs of the RAN 122 via the OSSs 138 to be stored in the datastore 134.

The incident reporting system 132 is a system implemented by one or more computers. The incident reporting system 132 records, tracks, and reports incidents that occur in the network 120 and/or the RAN 122. Incident reports may be referred to in some contexts or by other communication service providers as tickets or trouble tickets. In some instances, an incident report (or ticket) may be opened manually by NOC personnel. For example, the NOC dashboard system 102 can access the alarms stored in the datastore 134 and provide a list of alarms on a display screen used by NOC personnel. NOC personnel can manually open incident reports on these alarms using the incident reporting system 132. In other instances, an incident report may be opened automatically based on certain automation rules (e.g., related to certain alarms). For example, the incident reporting system 132 can monitor the alarms stored in the datastore 134 and automatically generate incident reports on these alarms based in part on the automation rules. As an example, a certain automation rule may specify that an incident report is not to be opened related to a specific alarm until the alarm has been active for a predefined period of time, for example for five minutes, for ten minutes, for fifteen minutes, for twenty minutes, for twenty-five minutes, or some other period of time less than two hours. The time criteria for auto generation of incident reports may be useful to avoid opening and tracking incidents that are automatically resolved by other components of the system 100.

In some instances, the incident reporting system 132 can determine that a plurality of alarms are related to a large-scale event (LSE) and generate a master incident report that covers the LSE. Alarms that are deemed related to the LSE are documented in the LSE master incident report, and the alarm information stored in the datastore 134 may be updated to indicate that these alarms are associated with the LSE and/or with the LSE master incident report. In some instances, the incident reporting system 132 may update incident reports documenting alarms that the incident reporting system 132 deems to be associated with an LSE by adding an indication into the incident report linking it to or associating it to the LSE master incident report. These incident reports that are linked to the LSE master incident report may be referred to as child incident reports. In some instances, the incident reporting system 132 may track and store incident reports (e.g., including the symptoms, root causes, and/or resolutions for the respective incidents) and/or associated LSE(s) in the datastore 134.

The datastore 134 stores network operational data 136 data related to operations in the RAN 122 and/or portions of the network 120 (e.g., the core network that connects the RAN 122 to other data networks). An example of a 5G core network is discussed below with reference to FIGS. 7A and 7B. As discussed above, the cell site maintenance tracking system 130 may record and track the maintenance activities in the datastore 134, the OSSs 138 may store alarms (flowed from the NEs in the RAN 122 and/or the respective core network) in the datastore 134, and the incident reporting system 132 may record and track incident reports in the datastore 134. Accordingly, the network operational data 136 stored in the datastore 134 may include current maintenance activities, current alarms, opened incidents (or tickets), and a history of past maintenance activities, past alarms, past incidents, symptoms related to those past incidents, root causes for those past incidents, and/or resolutions for the past incidents. As such, the network operational data 136 in the datastore 134 can provide a wealth of information about the network conditions in the RAN 122 and/or portions of the network 120. However, the amount of data can be vast and may be complex and time consuming for humans to digest and analyze. As will be discussed more fully below, the NOC dashboard system 102 may utilize an AI assistant to bridge the gap between the complex data and insights into the health of the RAN 122 and/or portions of the network 120. In an embodiment, the datastore 134 may be a vector database. For instance, each data entry in datastore 134 may be represented as a vector in a multi-dimensional space. The vectors can represent a wide range of information, such as embeddings from alarms, maintenance activities, and incident reports, etc. A vector database can efficiently store and index multi-dimensional data and allow for efficient search in the multi-dimensional data. In an embodiment, the datastore 134 may be a graph database, where data are stored as nodes connected by edges representing relations among respective data. For instance, the data may be arranged according to connections of the cell sites and/or hops within the network system 100. Such an arrangement may assist tracing of connectivity issues in the RAN 122 and/or portions of the network 120.

The NOC dashboard system 102 is a system that NOC personnel can use to monitor the health of a carrier network (e.g., monitor the RAN 122 and at least portions of the network 120), to monitor alarms, to drill down to get more details on alarms and on NE status, to review incident reports, and to take corrective actions to restore NEs to normal operational status. The NOC dashboard system 102 may interact with the datastore 134, with the cell site maintenance tracking system 130, the OSSs 138, the RAN 122, and other systems. NOC personnel can use the NOC dashboard system 102 to manually create incident reports based on alarms reviewed via a UI 105 of the NOC dashboard system 102.

According to an embodiment of the present disclosure, the NOC dashboard system 102 utilizes an AI assistant (e.g., the AI assistant application 112) to provide user-friendly insights into the health or network conditions of the RAN 122 and/or portions of the network 120 based on the complex network operational data 136 collected in the datastore 134. For instance, the NOC dashboard system 102 includes at least one processor and at least one non-transitory memory. The NOC dashboard system 102 includes a dashboard application 108 comprising instructions stored in the at least one non-transitory memory and executable by the at least one processor. The dashboard application 108 provides a display of information (e.g., alarms, incident reports, maintenance activities) associated with the network conditions in the RAN 122 and portions of the network 120 (e.g., the core network that connects the RAN 122 to other data network). The dashboard application 108 also provides the UI 105 including a natural language user interface 104 (a “chat interface”) and a GUI 106 for communications with NOC personnel.

In an embodiment, the dashboard application 108 may receive a request from a user (e.g., NOC personnel) via the natural language user interface 104 and/or the GUI 106. In one example, the request is a natural language question received via the natural language user interface 104. For instance, the natural language question may be “what is the health of the network?”, “what is the leading issue in the network?”, “what is the next leading issue in the network?”, “what is the high-priority issues in this particular country (e.g., U.S, Canada, Mexico, etc.)?”, “what is the high-priority issues in this particular area (e.g., a particular state, a particular county, a particular city, etc.) ?”, “what is the network unavailability?”, “what is the market segment unavailability?”, “what is a cell site unavailability?”, or “can you summarize what is going on in the network?”. The dashboard application 108 may communicate with the AI assistant application 112 in the GPT gateway 110 to obtain a natural language response to the question and provide the natural language response to the user. In another example, the request may be a user input received via the GUI 106 (e.g., a click to a button), and the request may be a request for a summary of a worklog (e.g., history of maintenance activities, alarms, and/or incidents) for the RAN 122 (e.g., certain cell site(s)) and/or portions of the network 120. The dashboard application 108 may communicate with the AI assistant application 112 in the GPT gateway 110 to obtain a summary of the worklog and provide the summary to the user.

The GPT gateway 110 (e.g., a computer system) includes at least one processor and at least one non-transitory memory. The GPT gateway 110 includes the AI assistant application 112 comprising instructions stored in the at least one non-transitory memory and executable by the at least one processor. The AI assistant application 112 utilizes one or more LLMs 114 to generate responses to questions received from a user at the NOC dashboard system 102. At a high level, the AI assistant application 112 may generate contextual information associated with the received question. The AI assistant application 112 may generate prompts to guide an LLM 114 in generating a response to a user question (a natural language question) based on the contextual information. The AI assistant application 112 may provide a callback function (e.g., a particular data retrieval function) for the LLM 114 to retrieve network operational data 136 from the datastore 134 that is relevant to the user question. The AI assistant application 112 may select the particular data retrieval function from a plurality of data retrieval functions based on the contextual information associated with the question. The LLM 114 may generate a response to the question using the retrieved network operational data 136 and the prompts. The response may include insights into the network conditions of the RAN 122 and/or portions of the network 120.

The LLMs 114 may include various types of LLMs 114, for example, including, but not limited to, one or more OpenAI^{®}models (e.g., a GPT-3 model, a GPT-3.5 model, a GPT-4 model), one or more open-source LLMs, an LLM Meta AI (Llama) model, and a Google Gemini® model. The different LLMs 114 may have different performances. For instance, the different LLMs may have different architectures (e.g., different transformers) and may be trained on different types of datasets and/or different amounts of data. The different LLMs may also have different associated costs (e.g., in terms of computational resources, memory resources, and/or subscription or service costs for using the respective LLMs). Generally, the higher the performance of the LLM, the higher the cost. In an example, one LLM 114 (e.g., a high-performance LLM) may be proficient at answering questions that require analyzing and reasoning to gain insights into the network conditions of the RAN 122 and/or at least portions of the network 120, and another LLM 114 (e.g., a low-performance LLM) may be good at generating summaries. Accordingly, in an embodiment, upon the AI assistant application 112 receiving a user question from the NOC dashboard system 102, the AI assistant application 112 may determine contextual information based on the received question and select, based on the contextual information, a particular LLM 114 from the LLMs 114 to generate a response to the question.

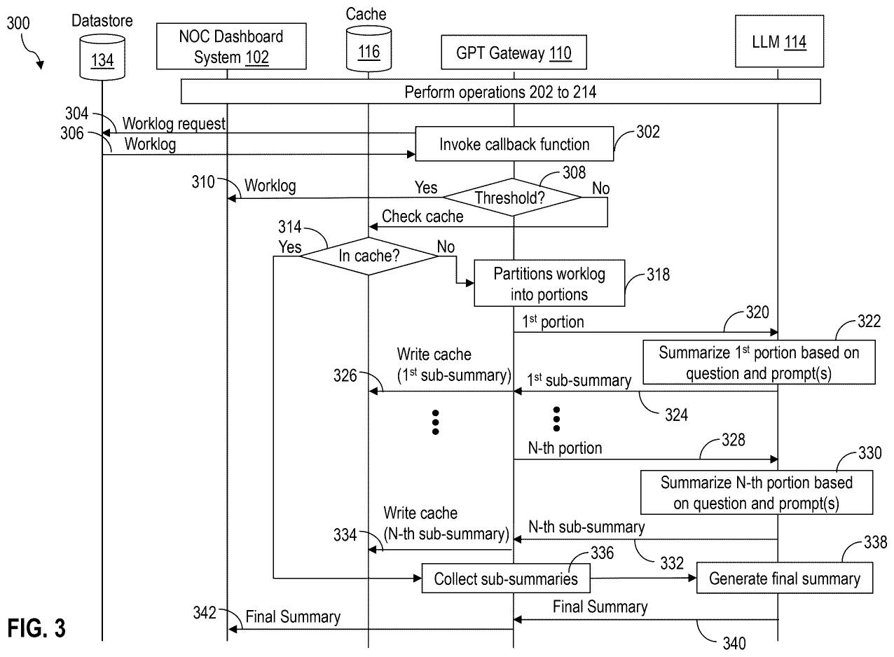

In some embodiments, the AI assistant application 112 may store responses and/or summaries (of worklogs in the network operational data 136) received from the LLM 114 in the cache 116 and may reuse a response or a summary stored in the cache 116 to respond to a subsequent question, if available, instead of invoking an LLM 114 (to generate a response to the question) as will be discussed more fully below with reference to FIGS. 3-6. Reusing a response or a summary can advantageously save computational complexity and cost. In some instances, the cache 116 may be arranged in a table format. In some instances, each response or summary stored in the cache 116 may be attached with and identified by a signature. The signature may include the prompt(s) and the particular LLM 114 used for generating the respective response or summary. Generally, the cache 116 may be arranged in any suitable way and the signatures for respective response or summary can include any suitable information.

In some embodiments, the GPT gateway 110 may further include a conversation stack 113 (e.g., stored in memory of the GPT gateway 110). The AI assistant application 112 may store questions or requests and corresponding responses or summaries exchanged between NOC personnel via the NOC dashboard system 102 and the AI assistant application 112 in the conversation stack 113. The AI assistant application 112 may also store generated prompts and/or selected data retrieval function for each question or request in the conversation stack 113. The AI assistant application 112 may assign a conversation identifier (ID) to a particular conversation (e.g., including multiple questions and respective response in the conversation stack 113) and associate the conversation ID with each question and corresponding response, and prompts and/or selected data retrieval function for generating the corresponding response. In this way, the conversation can be continued based on the conversation ID.

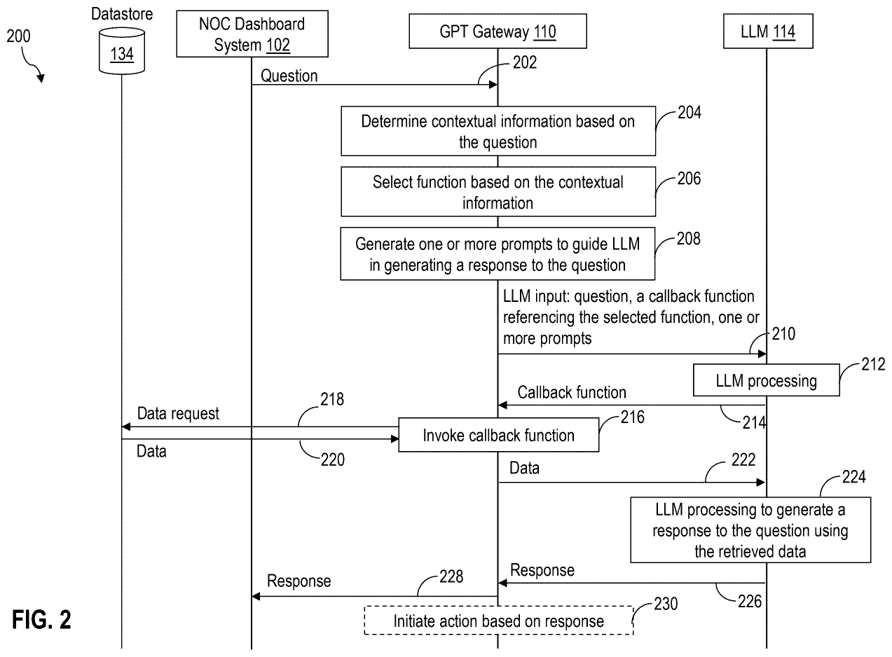

In some embodiments, the GPT gateway 110 may further include a recommendation engine 115 to generate recommended questions that a user may ask to start a conversation about the health of the RAN 122 and/or portions of the network 120. The recommendation engine 115 may also generate recommended follow-up questions that a user may ask after receiving an initial question from the user. In some embodiments, the NOC dashboard system 102 may further include a speech-text conversion engine 109 to convert speech to text or vice versa. For instance, NOC personnel may ask questions related to the health of the RAN 122 and/or portions of the network 120 using a voice command instead of text. The speech-text conversion engine 109 may convert the voice command to text and the dashboard application 108 may send the request in a textual form to the AI assistant application 112. The AI assistant application 112 may generate a response (in text) to the request. The AI assistant application 112 may provide the response to the dashboard application 108, and the speech-text conversion engine 109 may convert the textual response into an audio response for the user. Mechanisms for utilizing an AI assistant to provide user-friendly insights into the network conditions of the RAN based on complex network operational data 136 will be discussed more fully below with reference to FIGS. 2-6.

FIG. 1 is merely an example of components of a network system that utilizes an AI assistant to provide insights into health of a RAN and/or other connected network (e.g., a core network), and variations are contemplated to be within the scope of the present disclosure. In embodiments, the network system may include other components not illustrated in FIG. 1. In embodiments, the network system may not include every component illustrated in FIG. 1. In embodiments, the components and connections may be implemented with different connections than those illustrated in FIG. 1. While FIG. 1 illustrates the NOC dashboard system 102 as a separate system from the GPT gateway 110, the GPT gateway 110 can be implemented as part of the NOC dashboard system 102. Further, in examples, at least some of the LLMs 114 and/or the cache 116 may be implemented as part of the GPT gateway 110. Such and other embodiments are contemplated to be within the scope of the present disclosure.

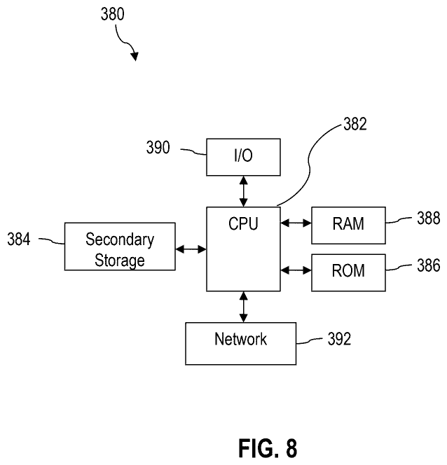

Turning now to FIG. 2, a method 200 of performing network management and maintenance operations using AI assistance is described. The method 200 illustrates operations performed by various components of the network system 100. Specifically, the components include the datastore 134, the NOC dashboard system 102, the GPT gateway 110, and an LLM 114. However, it is contemplated that other component(s) of the network system 100 may be involved in performing the operations of the method 200. In embodiments, each of the NOC dashboard system 102, the GPT gateway 110, and an LLM 114 may implement the operations of the method 200 using a computer system with components as shown in FIG. 8. As illustrated, FIG. 2 includes a number of enumerated operations, but embodiments of the operations in FIG. 2 may include additional operations before, after, and in between the enumerated operations. In some embodiments, one or more of the enumerated operations may be omitted or performed in a different order.

In the method 200, the operations of the NOC dashboard system 102 may be performed by the dashboard application 108, and operations of the GPT gateway 110 may be performed by the AI assistant application 112. At operation 202, the NOC dashboard system 102 may transmit, and the GPT gateway 110 may receive a question. The question may be in natural language. The question may be initiated and entered by a user (e.g., NOC personnel) via the UI 105 (or more specifically the natural language user interface 104) provided by the dashboard application 108 at the NOC dashboard system 102. The question may be related to an inquiry about a network condition of the RAN 122 and/or portions of the network 120 (e.g., a respective core network that connects the RAN 122 to other data networks).

At operation 204, upon receiving the question, the GPT gateway 110 may determine contextual information associated with the question. The contextual information may include a national context, a cell site context, a market or service segment context, or an incident context. The national context may refer to nationwide network operations and/or performance in the network system. The cell site context may refer to operations and/or performance related to a specific cell site of the network system. The market or service segment context may refer to network operations and/or performance of a certain market or service segment in the network system. The incident context may refer to operations related to opened incident tickets and/or reports of resolved incidents (e.g., including symptoms, root causes, and resolutions) in the network. In some instances, the determination of the contextual information associated with the question may be based on a part or a module of the dashboard application 108 in which the question is initiated. As an example, if the question is initiated from a part of the application 108 related to nationwide operations, the GPT gateway 110 may determine that the question is related to a national context. As another example, if the question is initiated from a part of the application 108 related to operations of a specific site, the GPT gateway 110 may determine that the question is related to a site context. As yet another example, if the question is initiated from a part of the application 108 related to operations of a specific market or service segment, the GPT gateway 110 may determine that the question is related to a market or service segment context. As a further example, if the question is initiated from a part of the application related to incident tickets and/or incident reports, the GPT gateway 110 may determine that the question is related to an incident context. In some instances, the determination of the contextual information associated with the question may be based on a role associated with a user account in which the question is initiated. For instance, different NOC personnel may be responsible for maintaining different areas of network operations (e.g., national network operations, market or service segment specific operations, etc.), and thus a user account of the NOC personnel that initiated the question may indicate area or context associated with the question.

At operation 206, after determining the contextual information associated with the question, the GPT gateway 110 may select a function from a pool of data retrieval functions based on the contextual information. As discussed above, the network operational data 136 in the datastore 134 may include a history or log of RAN operations, reported incidents (e.g., including symptoms, root causes, and past resolutions), and other maintenance operations. Different data retrieval functions may retrieve different types of network operational data 136 from the datastore 134. For instance, the pool of data retrieval functions may include a first function to retrieve data 136 associated with nationwide network operations, performance, and/or issues (e.g., detected failures or fixes for a certain operation across the country), a second function to retrieve data 136 associated with a specific site (e.g., including detected failures or fixes for operations and/or performance related to the specific site), a third function to retrieve data 136 associated with a specific market or service segment (e.g., including detected failures or fixes for operations and/or performance related to 5G but not LTE), and a fourth function to retrieve data 136 associated with incident tickets that are opened, in-progress, and/or closed and/or associated incident reports.

At operation 208, the GPT gateway 110 may generate prompts based on the question and/or the contextual information to guide an LLM 114 to generate a response to the received question. A prompt can be a statement including a textual description of at least some of the contextual information. As an example, if the contextual information indicates that the received question is associated with nationwide network operations, the generated prompt may be “can you collect data associated with nationwide operations and analyze the data?”. As another example, if the contextual information indicates that the received question is associated with operations in a specific cell site, the generated prompt may be “can you collect data associated with operations in the specific cell site and analyze the data?”. As yet another example, if the contextual information indicates that the received question is associated with operations in a specific market or service segment, the generated prompt may be “can you collect data associated with operations in the specific market or service segment and analyze the data?”. As a further example, if the contextual information indicates that the received question is associated with incident tickets, the generated prompt may be “can you collect recently closed incident tickets and recently opened incident tickets?”. A prompt can also operate as a guardrail to guide the LLM 114 to limit the scope of the response to be within RAN or core network related information. For instance, the guardrail may state that “you may not answer anything other than information for X, Y, and Z related to the RAN 122”.

At operation 210, after generating the prompts, the GPT gateway 110 may provide the question, a callback function referencing the selected function, and the prompts as an input to the LLM 114 (e.g., via an application programming interface (API) call). The callback function indicates to the LLM 114 that additional data can be provided to the LLM 114 for generating the response to the question, if needed. For instance, one of the generated prompts may state that “if you need additional data to generate the response, you can request for the additional data by calling this callback function”. In some instances, the GPT gateway 110 may also include function arguments that the LLM 114 may use along with the selected function to request for the additional data. In an embodiment, the GPT gateway 110 may select the LLM 114 from a pool of LLMs 114 based on the received question and/or the generated prompts. As discussed above, different LLMs 114 may be proficient in performing different types of tasks. For example, one LLM 114 may be proficient in generating worklog summaries, and another LLM 114 may be proficient in providing deep insights into network conditions. Thus, the GPT gateway 110 may select the LLM 114 that is most suitable and proficient in answering the received question.

At operation 212, the LLM 114 may perform LLM processing to process the question and the prompts and may determine that additional data is needed. Thus, at operation 214, the LLM 114 may send, and the GPT gateway 110 may receive the callback function. At operation 216, upon receiving the callback function, the GPT gateway 110 may invoke the callback function (i.e., the selected function) to retrieve network operational data 136 from the datastore 134. As part of invoking the callback function, the GPT gateway 110 may send a data request to the datastore 134 as shown at operation 218 and may receive the requested data 136 from the datastore 134 as shown at operation 220. At operation 222, the GPT gateway 110 may provide the retrieved network operational data 136 to the LLM 114 and initiate the LLM 114 to generate a response for the question using the retrieved network operational data 136. At operation 224, the LLM 114 may perform LLM processing to generate a response to the question using the retrieved network operational data 136 and the prompts (provided to the LLM 114 at operation 210). At operation 226, the LLM 114 may send, and the GPT gateway 110 may receive the response to the question. In an embodiment, the response is a natural language response and may include information associated with at least one of a network unavailability, a market or service segment unavailability, a cell site unavailability, or incidents in the network. At operation 228, the GPT gateway 110 may provide the response (generated by the LLM 114) to the NOC dashboard system 102. The NOC dashboard system 102 may display the response (in natural language) via the natural language user interface 104.

In some embodiments, at operation 230, based on the response, the GPT gateway 110 may initiate an action, for example, to open an incident ticket and/or initiate an operation at an NE in the RAN 122 or the network 120. In some examples, the action may include a reset operation at the NE to correct an issue in the RAN 122 and/or the network 120. In some examples, the action may include an unlock operation or an overwrite operation to resume operations at the NE. In some examples, the action may include a software or firmware update at the NE to correct an issue in the RAN 122 and/or the network 120.

In some embodiments, the GPT gateway 110 may provide recommended questions that a user may ask to the NOC dashboard system 102. For instance, the recommendation engine 115 may generate recommended questions. The NOC dashboard system 102 may display those recommended questions via the UI 105 on a display device (e.g., a monitor) of the NOC dashboard system 102. The recommended questions are in natural language that a user (e.g., NOC personnel) may ask via the natural language user interface 104 provided by the dashboard application 108.

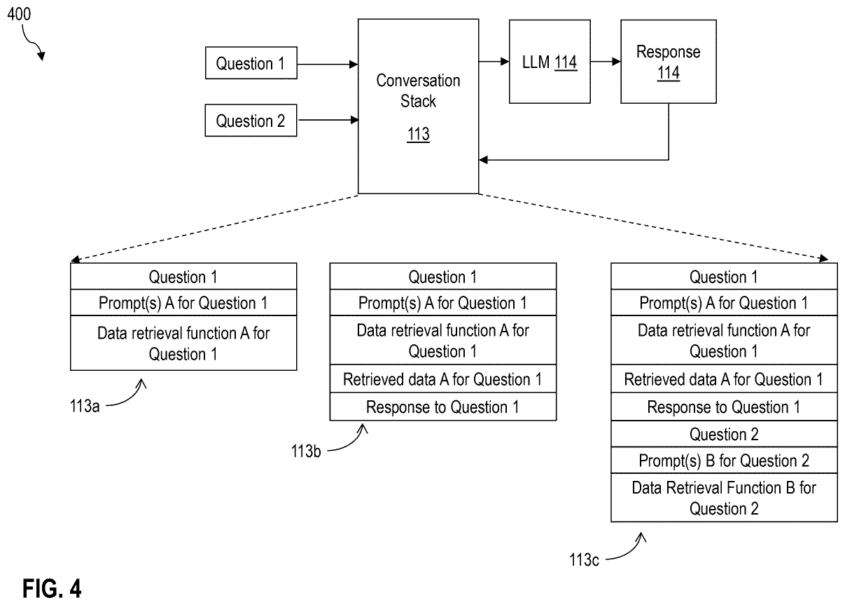

Some examples of recommended questions may include, but are not limited to, “what is the health of the network?”, “what is the leading issue in the network?”, “what is the next leading issue in the network?”, “what is the high-priority issues in this particular country (e.g., U.S, Mexico, etc.)?”, “what is the high-priority issues in this particular area (e.g., a particular state, a particular county, a particular city, etc.) ?”, “what is the network unavailability?”, “what is the market segment unavailability?”, “what is a cell site unavailability?”, and “can you summarize what is going on in the network?”. In an embodiment, the question received from the NOC dashboard system 102 at operation 202 may be based on the recommended questions provided by the GPT gateway 110. In other embodiments, the GPT gateway 110 may provide recommended follow-up questions. For instance, the GPT gateway 110 may provide one or more follow-up questions based on the question received at operation 202. That is, the user may continue the conversation after receiving the response via the NOC dashboard system 102 at operation 228. As will be discussed more fully below with reference to FIG. 4, a conversation stack may be used to facilitate an LLM 114 in generating responses in a conversation with multiple exchanges with a user of the NOC dashboard system 102.

In some embodiments, the question transmitted by the NOC dashboard system 102 to the GPT gateway 110 (at operation 202) may be initiated by the user using a voice command, and the question (in textual form) may be converted from the voice command using the speech-text conversion engine 109. Upon the NOC dashboard system 102 receiving the response from the GPT gateway 110 (at operation 228), the NOC dashboard system 102 may convert the response (in textual form) into an audio form using the speech-text conversion engine 109 and provide the response in the audio form to the user.

Turning now to FIG. 3, a method 300 of summarizing a network operational data log using AI assistance is described. The method 300 illustrates operations performed by various components of the network system 100. Specifically, the components include the datastore 134, the NOC dashboard system 102, the cache 116, the GPT gateway 110, and an LLM 114. However, it is contemplated that other component(s) of the network system 100 may be involved in performing the operations of the method 300. In embodiments, each of the NOC dashboard system 102, the GPT gateway 110, and an LLM 114 may implement the operations of the method 200 using a computer system with components as shown in FIG. 8. As illustrated, FIG. 3 includes a number of enumerated operations, but embodiments of the operations in FIG. 3 may include additional operations before, after, and in between the enumerated operations. In some embodiments, one or more of the enumerated operations may be omitted or performed in a different order.

In the method 300, the operations of the NOC dashboard system 102 may be performed by the dashboard application 108, and operations of the GPT gateway 110 may be performed by the AI assistant application 112. The method 300 includes similar features as the method 200. For example, the method 300 includes operations 202-214 of the method 200. For brevity, details of those operations are not repeated here and can be referred to the corresponding descriptions above.

At operation 302, after the GPT gateway 110 receives a callback function (a selected data retrieval function) from the LLM 114, the GPT gateway 110 may invoke the callback function to retrieve network operational data 136 from the datastore 134. In the illustrated example of FIG. 3, the request or question from the NOC dashboard system 102 to the GPT gateway 110 (e.g., at operation 202) may request for a summary of a worklog (e.g., a history of site conditions, incidents, and/or past resolutions in the RAN 122 and/or portions of the network 120, etc.), and thus the callback function or selected data retrieval function is to retrieve a worklog from the datastore 134. For instance, the callback function or selected data retrieval function may be represented by a function call: GetWorklog (arguments x, y, . . . ). Accordingly, as part of invoking the callback function, the GPT gateway 110 may send a worklog request to the datastore 134 as shown by operation 304 and may receive the worklog from the datastore 134 as shown by operation 306.

At operation 308, upon receiving the worklog, the GPT gateway 110 may determine whether a length of the worklog satisfies a certain threshold (e.g., about 4000 characters). In some examples, the threshold may be based on a capability of the LLM 114. For instance, the LLM 114 can process or summarize content in chunks of 4000 characters at a time. In other examples, the threshold may be based on a limitation imposed by a service subscription of the LLM 114. For instance, there is a fee or cost associated with each call to the LLM 114 (provided by a certain third-party or vendor) and the LLM 114 can process or summarize content in chunks of about 4000 characters at a time for the level of service provisioned by the fee. At operation 310, if the length of the worklog satisfies the threshold (e.g., less than or equal to 4000 characters), the GPT gateway 110 may provide the worklog to the NOC dashboard system 102. For instance, if the length of the worklog is sufficiently short (e.g., less than or equal to 4000 characters), the GPT gateway 110 can provide the worklog to the NOC dashboard system 102 as is without summarizing the worklog.

If, however, the length of the worklog fails to satisfy the threshold, the GPT gateway 110 may proceed to operation 314 to check the cache 116. At operation 314, the GPT gateway 110 may determine whether there is a summary for the worklog (or at least a portion of the worklog) stored in the cache 116. If there is no summary (or sub-summaries) for the worklog available in the cache 116, the GPT gateway 110 may proceed to operation 318.

At operation 318, the GPT gateway 110 may partition the worklog into N portions (e.g., multiple chunks of 4000 characters or less), where N may be an integer and may depend on the length of the worklog. Next, at operation 320, the GPT gateway 110 may provide a first portion of the worklog to the LLM 114 and request the LLM 114 to summarize the first portion. At operation 322, the LLM 114 may summarize the first portion based on the question (received from the NOC dashboard system 102, e.g., at operation 202) and the prompts (generated by the GPT gateway 110, e.g., at operation 208). The question and prompts may be provided previously by the GPT gateway 110 to the LLM 114 (e.g., at operation 210). At operation 324, the LLM 114 may provide a first sub-summary for the first portion of the worklog to the GPT gateway 110. At operation 326, the GPT gateway 110 may write (or store) the first sub-summary (for the first portion of the worklog) to the cache 116. The GPT gateway 110 may continue to provide subsequent portions of the worklog to the LLM 114 one-by-one and request the LLM 114 to summarize the respective portion and write (or store) each sub-summary received from the LLM 114 to the cache 116 until the N-th portion is summarized. As shown, at operation 328, the GPT gateway 110 may provide an N-th portion of the worklog to the LLM 114 and request the LLM 114 to summarize the N-th portion. At operation 330, the LLM 114 may summarize the N-th portion based on the question (received from the NOC dashboard system 102, e.g., at operation 202) and the prompts (generated by the GPT gateway 110, e.g., at operation 208). At operation 332, the LLM 114 may provide an N-th sub-summary for the N-th portion of the worklog to the GPT gateway 110. At operation 334, the GPT gateway 110 may write (or store) the N-th sub-summary (for the N-th portion of the worklog) to the cache 116.

At operation 336, after receiving the N-th sub-summary for the last portion of the worklog, the GPT gateway 110 may collect all the N sub-summaries received from the LLM 114 and provide all N sub-summaries to the LLM 114 and request a final summary from the LLM 114. In some instances, the AI assistant application 112 can select another LLM 114 to generate the final summary instead of using the same LLM 114 that generated the sub-summaries. At operation 338, the LLM 114 may generate a final summary based on the collection of N sub-summaries. At operation 340, the LLM 114 may provide the final summary to the GPT gateway 110. At operation 342, the GPT gateway 110 may provide the final summary to the NOC dashboard system 102. The NOC dashboard system 102 may provide the final summary for the worklog to the user via the natural language user interface 104.

Returning to operation 314, if there is a summary (or sub-summaries) for the worklog available in the cache 116, the GPT gateway 110 may proceed to operation 336. The GPT gateway 110 may reuse the cached summary (or sub-summaries) and may request the LLM 114 to generate a final summary as discussed above. In some instances, GPT gateway 110 may validate the cache 116 (e.g., to ensure that the responses in the cache memory is current and valid) prior to using the summary (or sub-summaries) stored in the cache 116.

In some embodiments, the GPT gateway 110 may assign a signature to each sub-summary stored in the cache 116 (e.g., at operations 326 and 334) and may attach the signature to the respective sub-summary in the cache 116. As discussed above, the signature can be based on the prompts (generated by the GPT gateway 110) and the selected LLM 114 used for generating the respective sub-summary. Accordingly, when the GPT gateway 110 determines whether there is a summary (or sub-summaries) in the cache 116 (at operation 314), the GPT gateway 110 may search the cache 116 based on the prompts and the selected data retrieval function (the callback function at operation 302). In some embodiments, the cache 116 may have cached a sub-summary for one or more portions (e.g., 1st to 3^{rd} portions) of the worklog but not all portions. In such embodiments, the GPT gateway 110 may request the LLM 114 to generate sub-summaries for the portions (e.g., 4^{th} to N-th portions) of the worklog without sub-summaries cached in the cache 116.

Turning now to FIG. 4, an example scenario 400 of using a conversation stack for AI assisted network management and maintenance is described. As discussed above, the GPT gateway 110 (or more specifically the AI assistant application 112) may maintain a conversation stack 113 to store information related to a particular conversation (which may include multiple questions and responses). The bottom portion of FIG. 4 illustrates various snapshots of the conversation stack 113 at different times. In the illustrated example of FIG. 4, the AI assistant application 112 may receive a first question (shown as Question 1) from the NOC dashboard system 102. The AI assistant application 112 may determine contextual information based on Question 1, generate one or more prompts (e.g., prompt(s) A), select an LLM 114 based on the contextual information, and select a data retrieval function (e.g., data retrieval function A) based on the contextual information as discussed above (e.g., at operations 204-208 of the method 200). The AI assistant application 112 may store Question 1, the generated prompt(s) A, and the data retrieval function A (a callback function) selected for Question 1 in the conversation stack as shown by 113a. The AI assistant application 112 may provide the conversation stack 113a to the selected LLM 114 and request the selected LLM 114 to generate a response to Question 1 based on the information in the conversation stack 113a. The LLM 114 may request data using the data retrieval function (or the callback function) and may generate a response to Question 1 using the prompt(s) for Question 1 and the retrieved data (e.g., retrieved data A). The LLM 114 may provide the response to Question 1 back to the AI assistant application 112. The AI assistant application 112 may update the conversation stack 113a to include the retrieved data for Question 1 and the response for Question 1 as shown by 113b.

Subsequently, the AI assistant application 112 may receive a second question (shown as Question 2) from the NOC dashboard system 102. The second question may be a follow-up to the first question. That is, Question 1 and Question 2 are part of the same conversation. As an example, Question 1 may be “what is a leading issue in the network?”, and Question 2 may be “what is the next leading issue in the network?”. The AI assistant application 112 may determine contextual information based on Question 2 and generate one or more prompts (e.g., prompt(s) B), and select a data retrieval function (e.g., data retrieval function B) based on the contextual information as discussed above (e.g., at operations 204-208 of the method 200). In some instances, the data retrieval function B for Question 2 may be the same as the data retrieval function A for Question 1. In other instances, the data retrieval function B for Question 2 may be different than the data retrieval function A for Question 1. The AI assistant application 112 may update the conversation stack 113a, for example, by adding Question 2, the generated prompt(s) B, and the data retrieval function B (a callback function) selected for Question 2 in the conversation stack as shown by 113c. The AI assistant application 112 may provide the conversation stack 113c to the selected LLM 114 and request the LLM 114 to generate a response to Question 2 based on the conversation stack 113c. The AI assistant application 112 may continue to receive follow-up questions after Question 2 (e.g., “what is the root cause for the leading issue and/or the next leading issue?”, “what tool(s) can I use to further diagnose the issue?”, etc.) and continue to update the conversation stack 113 using similar mechanisms as discussed. Because there is a limit on the amount of memory that can be occupied by the conversation stack 113, the AI assistant application 112 may apply a rolling window technique to the conversation stack 113. That is, an older conversation can be overwritten by a newer conversation.

Providing the entire conversation (e.g., including previous question(s), response(s), data retrieval function(s), and retrieved data) to the LLM 114 as the conversation continues can allow the LLM 114 to generate more informational or relevant responses. In some cases, the AI assistant application 112 may have multiple on-going conversation threads. In some examples, the different conversation threads may be with different NOC personnel. In other examples, the different conversation threads may be with the same NOC personnel but on different topics. To track the different conversation threads, the AI assistant application 112 may assign a different and unique conversation ID for each conversation thread and may associate corresponding conversation exchanges (e.g., including previous question(s), response(s), data retrieval function(s), and retrieved data) with the conversation ID. In this way, a particular conversation can be resumed or continued based on the conversation ID. For instance, the AI assistant application 112 may provide the portion(s) of the conversation stack associated with a particular conversation ID to the LLM 114 when responding to a subsequent question related to that particular conversation identified by the conversation ID. In some instances, the AI assistant application 112 may allocate different portions of the conversation stack 113 for different conversation threads. Generally, the AI assistant application 112 may arrange the conversation stack 113 in any suitable way.

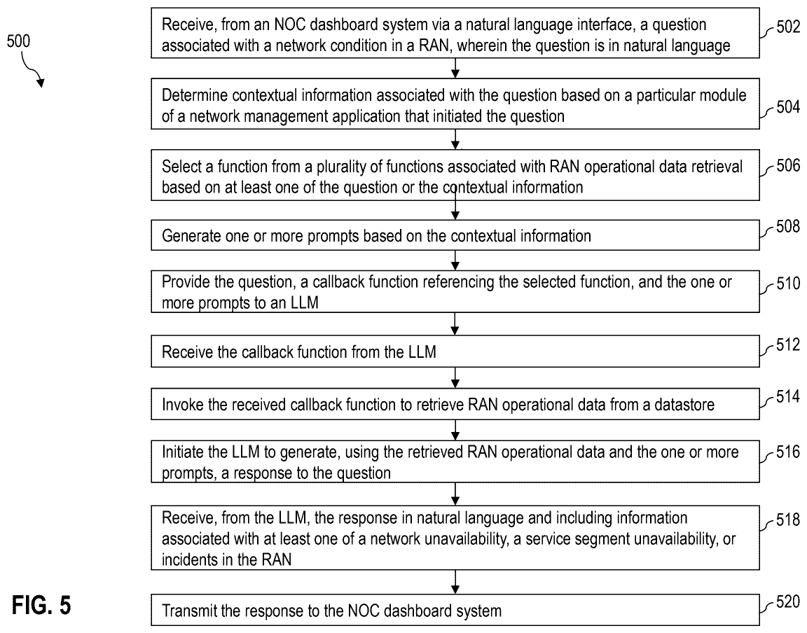

Turning now to FIG. 5, a method 500 is described. In an embodiment, the method 500 is a method of retrieving and providing information associated network conditions of a RAN based on a source of a question using AI assistance. The method 500 is implemented by a GPT gateway 110 (or more specifically by an AI assistant application 112). The method 500 may include similar mechanisms as discussed above with reference to FIGS. 1-4. In embodiments, the method 500 may be implemented using a computer system with components as shown in FIG. 8. As illustrated, FIG. 5 includes a number of enumerated operations, but embodiments of the operations in FIG. 5 may include additional operations before, after, and in between the enumerated operations. In some embodiments, one or more of the enumerated operations may be omitted or performed in a different order.

At block 502, an AI assistant application 112 receives, from an NOC dashboard system 102 via a natural language user interface 104, a question associated with a network condition in a RAN 122, where the question is in natural language. At block 504, the AI assistant application 112 determines contextual information associated with the question based on a particular module of a network management application that initiated the question. In an embodiment, the contextual information associated with the question comprises an indication of at least one of a national context, a service segment context, a cell site context, or an incident context. In an embodiment, the determining the contextual information is further based on at least one of a subsystem or an application of the NOC dashboard system that initiated the question or a role associated with a NOC user account that initiated the question. At block 506, the AI assistant application 112 selects a function from a plurality of functions associated with RAN operational data retrieval based on the contextual information. At block 508, the AI assistant application 112 generates one or more prompts based on the contextual information. The one or more prompts include textual descriptions to guide the LLM 114 to generate a response to the question. In an embodiment, at least one of the one or more prompts comprises a guardrail that guides the LLM 114 to limit a scope of the response to be within RAN related information.

At block 510, the AI assistant application 112 provides the question, a callback function referencing the selected function, and the one or more prompts to an LLM 114. At block 512, the AI assistant application 112 receives the callback function from the LLM 114. At block 514, the AI assistant application 112 invokes the received callback function to retrieve RAN operational data (e.g., the network operational data 136) from a datastore 134. In an embodiment, the callback function to retrieve the RAN operational data is based on a RAG process. At block 516, the AI assistant application 112 initiates the LLM 114 to generate a response to the question using the retrieved RAN operational data and the one or more prompts. At block 518, the AI assistant application 112 receives, from the LLM 114, the response in natural language and comprising information associated with at least one of a network unavailability, a service segment unavailability, a cell site unavailability, or incidents in the RAN 122. At block 520, the AI assistant application 112 transmits the response to the NOC dashboard system 102.

In an embodiment, the RAN operational data retrieved from the datastore 134 at block 514 comprises a worklog comprising a history of at least one of cell site conditions, incidents, or past resolutions in the RAN 122. Further, as part of initiating the LLM 114 to generate a response at block 516, the AI assistant application 112 initiates the LLM 114 to generate a summary of the worklog based on the question and the one or more prompts. In an embodiment, based on the event of a length of the worklog failing to satisfy a threshold as part of initiating the LLM 114 to generate the summary, the AI assistant application 112 partitions the worklog into a plurality of portions. Further, for each portion of the plurality of portions of the worklog, the AI assistant application 112 initiates the LLM 114 to summarize the respective portion. Further, as part of receiving the response from the LLM 114 at block 518, the AI assistant application 112 receives a plurality of sub-summaries, each for a respective portion of the plurality of portions of the worklog, and the response transmitted to the NOC dashboard system at block 520 is based on the plurality of sub-summaries. In an embodiment, as part of initiating the LLM 114 to generate the summary of the worklog, the AI assistant application 112 initiating the LLM to generate a final summary based on the plurality of sub-summaries. Further, as part of receiving the response from the LLM 114 at block 518, the AI assistant application 112 receives the final summary from the LLM 114. Further, as part of transmitting the response to the NOC dashboard system 102, the AI assistant application 112 transmits the final summary to the NOC dashboard system 102.

In an embodiment, the AI assistant application 112 further stores at least a portion of the response (received at block 518) in a cache 116. The AI assistant application 112 further receives, from the NOC dashboard system 102, a second question associated with a second network condition in the RAN 122, where the second question is also in natural language. The AI assistant application 112 further transmits, to the NOC dashboard system 102, a second response to the second question. The second response comprises the portion of the response stored in the cache 116 based on a determination that the portion of the response stored in the cache 116 is relevant to the second question and a validation of the cache 116. In an embodiment, the AI assistant application 112 further determines one or more recommended questions, and the question received from the NOC dashboard system 102 at block 502 is based on the one or more recommended questions.

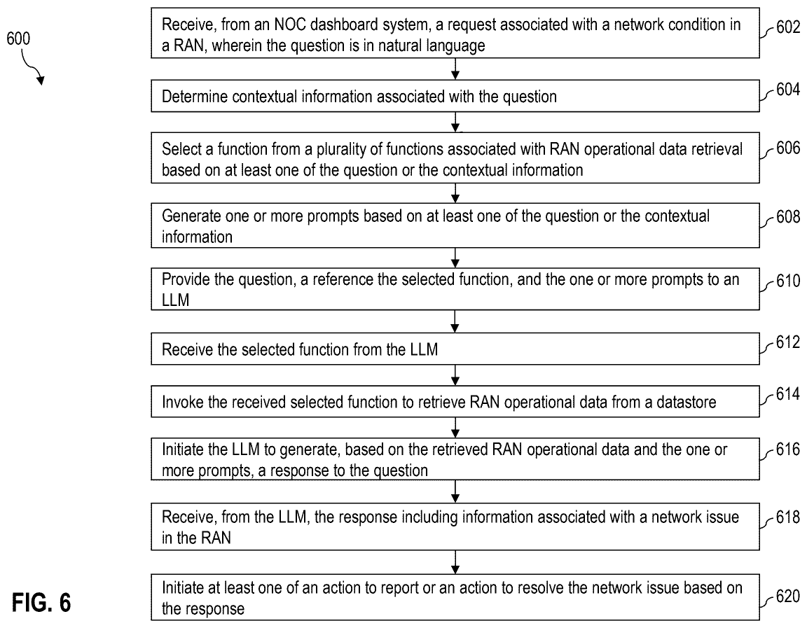

Turning now to FIG. 6, a method 600 is described. In an embodiment, the method 600 is a method of automating network management and maintenance operations in a RAN 122 using AI assistance. The method 600 is implemented by a GPT gateway 110 (or more specifically by an AI assistant application 112). The method 600 may include similar mechanisms as discussed above with reference to FIGS. 1-5. In embodiments, the method 600 may be implemented using a computer system with components as shown in FIG. 8. As illustrated, FIG. 6 includes a number of enumerated operations, but embodiments of the operations in FIG. 6 may include additional operations before, after, and in between the enumerated operations. In some embodiments, one or more of the enumerated operations may be omitted or performed in a different order.

At block 602, an AI assistant application 112 receives, from an NOC dashboard system 102, a request for information associated with a network condition in a RAN 122. At block 604, the AI assistant application 112 determines contextual information associated with the question. At block 606, the AI assistant application 112 selects a function from a plurality of functions associated with RAN operational data retrieval based on contextual information associated with the request. At block 608, the AI assistant application 112 generates one or more prompts based on at least one of the request or the contextual information.

At block 610, the AI assistant application 112 provides the request, a reference to (or an indication of) the selected function, and the one or more prompts to an LLM 114. In an embodiment, the AI assistant application 112 selects the LLM 114 from a plurality of different LLMs based on at least one of the request, the contextual information, or the one or more prompts. At block 612, the AI assistant application 112 receives the selected function from the LLM 114. At block 614, the AI assistant application 112 invokes the received selected function to retrieve RAN operational data (e.g., the network operational data 136) from a datastore 134. In an embodiment, the RAN operational data comprises log data associated with at least one of operations, maintenance, or alarms in the RAN. At block 616, the AI assistant application 112 initiates the LLM 114 to generate a response to the request based on the retrieved RAN operational data and the one or more prompts. At block 618, the AI assistant application 112 receives, from the LLM 114, the response including information associated with a network issue in the RAN 122.

At block 620, the AI assistant application 112 initiates at least one of an action to report or an action to resolve the network issue based on the response. In an embodiment, as part of initiating the action to report the network issue, the AI assistant application 112 creates an incident ticket in an incident reporting system 132 based on the response received from the LLM 114. In an embodiment, as part of initiating the action to report the network issue, the AI assistant application 112 initiates an operation at a network element based on the response received from the LLM 114. In some examples, the AI assistant application 112 may reset a component at the NE. In some examples, the AI assistant application 112 may cause a software or firmware update at the NE.

Turning now to FIG. 7A, an exemplary communication system 550 is described. Typically, the communication system 550 includes a number of access nodes 554 that are configured to provide coverage in which UEs 552 such as cell phones, tablet computers, machine-type-communication devices, tracking devices, embedded wireless modules, and/or other wirelessly equipped communication devices (whether or not user operated), can operate. The access nodes 554 may be said to establish an access network 556. The access network 556 may be referred to as a radio access network (RAN) in some contexts. In a 5G technology generation an access node 554 may be referred to as a next Generation Node B (gNB). In 4G technology (e.g., LTE technology) an access node 554 may be referred to as an evolved Node B (eNB). In 3G technology (e.g., code division multiple access (CDMA) and global system for mobile communication (GSM)) an access node 554 may be referred to as a base transceiver station (BTS) combined with a base station controller (BSC). In some contexts, the access node 554 may be referred to as a cell site or a cell tower. In some implementations, a picocell may provide some of the functionality of an access node 554, albeit with a constrained coverage area. Each of these different embodiments of an access node 554 may be considered to provide roughly similar functions in the different technology generations.

In an embodiment, the access network 556 comprises a first access node 554a, a second access node 554b, and a third access node 554c. It is understood that the access network 556 may include any number of access nodes 554. Further, each access node 554 could be coupled with a core network 558 that provides connectivity with various application servers 559 and/or a network 560. In an embodiment, at least some of the application servers 559 may be located close to the network edge (e.g., geographically close to the UE 552 and the end user) to deliver so-called “edge computing.” The network 560 may be one or more private networks, one or more public networks, or a combination thereof. The network 560 may comprise the public switched telephone network (PSTN). The network 560 may comprise the Internet. With this arrangement, a UE 552 within coverage of the access network 556 could engage in air-interface communication with an access node 554 and could thereby communicate via the access node 554 with various application servers and other entities.

The communication system 550 could operate in accordance with a particular radio access technology (RAT), with communications from an access node 554 to UEs 552 defining a downlink or forward link and communications from the UEs 552 to the access node 554 defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G”—such as LTE, which now facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile mmWave (e.g., frequency bands above 24 GHz), and/or other features, to support higher data rates and countless applications, such as mission-critical services, enhanced mobile broadband, and massive IoT. 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general internet service providers for laptops and desktop computers, competing with existing ISPs such as cable internet, and also will make possible new applications in internet of things (IoT) and machine to machine areas.

In accordance with the RAT, each access node 554 could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in radio-frequency (RF) spectrum) having a bandwidth and a center frequency and thus extending from a low-end frequency to a high-end frequency. Further, on the downlink and uplink channels, the coverage of each access node 554 could define an air interface configured in a specific manner to define physical resources for carrying information wirelessly between the access node 554 and UEs 552.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the access node could allocate as needed to carry data between the access node and served UEs 552.

In addition, certain resource elements on the example air interface could be reserved for special purposes. For instance, on the downlink, certain resource elements could be reserved to carry synchronization signals that UEs 552 could detect as an indication of the presence of coverage and to establish frame timing, other resource elements could be reserved to carry a reference signal that UEs 552 could measure in order to determine coverage strength, and still other resource elements could be reserved to carry other control signaling such as PRB-scheduling directives and acknowledgement messaging from the access node 554 to served UEs 552. And on the uplink, certain resource elements could be reserved to carry random access signaling from UEs 552 to the access node 554, and other resource elements could be reserved to carry other control signaling such as PRB-scheduling requests and acknowledgement signaling from UEs 552 to the access node 554.

The access node 554, in some instances, may be split functionally into a radio unit (RU), a distributed unit (DU), and a central unit (CU) where each of the RU, DU, and CU have distinctive roles to play in the access network 556. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center.

Turning now to FIG. 7B, further details of the core network 558 are described. In an embodiment, the core network 558 is a 5G core network. 5G core network technology is based on a service based architecture paradigm. Rather than constructing the 5G core network as a series of special purpose communication nodes (e.g., an HSS node, a MME node, etc.) running on dedicated server computers, the 5G core network is provided as a set of services or network functions. These services or network functions can be executed on virtual servers in a cloud computing environment which supports dynamic scaling and avoidance of long-term capital expenditures (fees for use may substitute for capital expenditures). These network functions can include, for example, a user plane function (UPF) 579, an authentication server function (AUSF) 575, an access and mobility management function (AMF) 576, a session management function (SMF) 577, a network exposure function (NEF) 570, a network repository function (NRF) 571, a policy control function (PCF) 572, a unified data management (UDM) 573, a network slice selection function (NSSF) 574, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G core network 558 may be segregated into a user plane 580 and a control plane 582, thereby promoting independent scalability, evolution, and flexible deployment.

The UPF 579 delivers packet processing and links the UE 552, via the access network 556, to a data network 590 (e.g., the network 560 illustrated in FIG. 7A). The AMF 576 handles registration and connection management of non-access stratum (NAS) signaling with the UE 552. Said in other words, the AMF 576 manages UE registration and mobility issues. The AMF 576 manages reachability of the UEs 552 as well as various security issues. The SMF 577 handles session management issues. Specifically, the SMF 577 creates, updates, and removes (destroys) protocol data unit (PDU) sessions and manages the session context within the UPF 579. The SMF 577 decouples other control plane functions from user plane functions by performing dynamic host configuration protocol (DHCP) functions and Internet protocol (IP) address management functions. The AUSF 575 facilitates security processes.

The NEF 570 securely exposes the services and capabilities provided by network functions. The NRF 571 supports service registration by network functions and discovery of network functions by other network functions. The PCF 572 supports policy control decisions and flow based charging control. The UDM 573 manages network user data and can be paired with a user data repository (UDR) that stores user data such as customer profile information, customer authentication number, and encryption keys for the information. An application function 592, which may be located outside of the core network 558, exposes the application layer for interacting with the core network 558. In an embodiment, the application function 592 may be executed on an application server 559 located geographically proximate to the UE 552 in an “edge computing” deployment mode. The core network 558 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 574 can help the AMF 576 to select the network slice instance (NSI) for use with the UE 552.

FIG. 8 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, RAM 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, USB interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), IP, time division multiplex (TDM), data over cable service interface specification (DOCSIS), wavelength division multiplexing (WDM), and/or the like. In an embodiment, the radio transceiver cards may provide wireless communication links using protocols such as CDMA, global system for mobile communications (GSM), LTE, WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method to automate network management and maintenance operations in a radio access network (RAN), the method comprising:
receiving, by an artificial intelligence (AI) assistant application executing on a computer system, from a network operations center (NOC) dashboard system, a request for information associated with a network condition in a RAN;
selecting, by the AI assistant application, based on contextual information associated with the request, a function from a plurality of functions associated with RAN operational data retrieval;
generating, by the AI assistant application, based on at least one of the request or the contextual information, one or more prompts;
providing, by the AI assistant application, to a large language model (LLM), the request, a reference to the selected function, and the one or more prompts;
receiving, by the AI assistant application, from the LLM, the selected function;
invoking, by the AI assistant application, the received selected function to retrieve, from a datastore, RAN operational data;
initiating, by the AI assistant application, the LLM to generate a response to the request based on the retrieved RAN operational data and the one or more prompts;
receiving, by the AI assistant application from the LLM, the response including information associated with a network issue in the RAN; and
initiating, by the AI assistant application, at least one of an action to report or an action to resolve the network issue based on the response.

2. The method of claim 1, further comprising:
determining, by the AI assistant application, the contextual information associated with the request, wherein the contextual information is associated with at least one of a national context, a service segment context, a cell site context, or an incident context.

3. The method of claim 1, wherein the RAN operational data comprises log data associated with at least one of operations, maintenance, or alarms in the RAN.

4. The method of claim 1, wherein the initiating the action to report the network issue comprises:
creating, by the AI assistant application, an incident ticket in an incident reporting system based on the response received from the LLM.

5. The method of claim 1, wherein the initiating the action to resolve the network issue comprises:
initiating, by the AI assistant application, an operation at a network element based on the response received from the LLM.

6. The method of claim 1, further comprising:
selecting, by the AI assistant application, the LLM from a plurality of different LLMs based on at least one of the request, the contextual information, or the one or more prompts.

7. A method implemented in a network system to automatically retrieve and provide information associated with network conditions in a particular context of a radio access network (RAN) based on a source of a question using artificial intelligence (AI) assistance, the method comprising:
receiving, by an AI assistant application executing on a computer system, from a network operations center (NOC) dashboard system via a natural language user interface, a question associated with a network condition in a RAN, wherein the question is in natural language;
determining, by the AI assistant application, contextual information associated with the question based on a particular module of a network management application that initiated the question, wherein the contextual information is associated with at least one of a national context, a service segment context, a cell site context, or an incident context;
selecting, by the AI assistant application, based on the contextual information, a function from a plurality of functions associated with RAN operational data retrieval;
generating, by the AI assistant application one or more prompts based on the contextual information;
providing, by the AI assistant application, to a large language model (LLM), the question, a callback function referencing the selected function, and the one or more prompts;
receiving, by the AI assistant application, from the LLM, the callback function;
invoking, by the AI assistant application, the received callback function to retrieve RAN operational data from a datastore;
initiating, by the AI assistant application, the LLM to generate, using the retrieved RAN operational data and the one or more prompts, a response to the question;
receiving, by the AI assistant application, from the LLM, the response in natural language and comprising information associated with the network condition; and
transmitting, by the AI assistant application, the response to the NOC dashboard system.

8. The method of claim 7, wherein the response received from the LLM comprises at least one of a network unavailability, a service segment unavailability, a cell site unavailability, or incidents in the RAN.

9. The method of claim 7, wherein:
the RAN operational data retrieved from the datastore comprises a worklog comprising a history of at least one of cell site conditions, incidents, or past resolutions in the RAN, and
the initiating the LLM to generate a response comprises:
initiating the LLM to generate a summary of the worklog based on the question and the one or more prompts.

10. The method of claim 9, wherein:
the initiating the LLM to generate the summary of the worklog comprises:
partitioning, based on a length of the worklog fails to satisfy a threshold, the worklog into a plurality of portions; and
initiating, for each portion of the plurality of portions of the worklog, the LLM to summarize the respective portion,
the receiving the response from the LLM comprises:
receiving, by the AI assistant application, a plurality of sub-summaries, each for a respective portion of the plurality of portions of the worklog, and
the response transmitted to the NOC dashboard system is based on the plurality of sub-summaries.

11. The method of claim 10, wherein:
the initiating the LLM to generate the summary of the worklog further comprises:
initiating the LLM to generate a final summary based on the plurality of sub-summaries, the receiving the response from the LLM further comprises:
receiving, by the AI assistant application, from the LLM, the final summary, and
the transmitting the response to the NOC dashboard system comprises:
transmitting the final summary to the NOC dashboard system.

12. The method of claim 7, further comprising:
storing, by the AI assistant application, at least a portion of the response in a cache;
receiving, by the AI assistant application, from the NOC dashboard system, a second question associated with a second network condition in the RAN, wherein the second question is in natural language; and
transmitting, by the AI assistant application, to the NOC dashboard system, a second response to the second question, wherein the second response comprises the portion of the response stored in the cache based on a determination that the portion of the response stored in the cache is relevant to the second question.

13. The method of claim 7, wherein at least one of the one or more prompts comprises a guardrail that guides the LLM to limit a scope of the response to be within RAN related information.

14. The method of claim 7, further comprising:
determining, by the AI assistant application, one or more recommended questions,
wherein the question received from the NOC dashboard system is based on the one or more recommended questions.

15. The method of claim 7, wherein the callback function to retrieve the RAN operational data is based on a retrieval augmentation generation (RAG) process.

16. A system comprising:
a network management dashboard system to:
provide a display of information associated with network conditions in a telecommunications network; and
provide a user interface (UI) to receive a request associated with network management in the telecommunications network;
a datastore to store network operational data associated with the telecommunications network;
a computer system comprising;
at least one processor;
at least one non-transitory memory; and
an artificial intelligence (AI) assistant application comprising instructions stored in the at least one non-transitory memory, which when executed by the at least one processor, causes the AI assistant application to:
receive, from the network management dashboard system, the request associated with a network condition in the telecommunication network;
determine contextual information based on the request;
initiate, based on the contextual information, a clickable button to be populated in the UI for activating an action to resolve an issue in the telecommunication network;
select, based on the contextual information and an activation of the clickable button, a function from a plurality of data retrieval functions;
generate, based on at least one of the request or the contextual information, one or more prompts;
provide, to a large language model (LLM), the request, the one or more prompts, and an indication of the selected function;
receive, from the LLM, a request to invoke the selected function;
execute the selected function to retrieve the network operational data from the datastore;
initiate the LLM to generate a response to the request based on the retrieved network operational data and the one or more prompts;
receive, from the LLM, the response including information associated with the network condition in the telecommunication network; and
initiate, based on the response, an action to resolve the issue in the telecommunication network.

17. The system of claim 16, wherein the contextual information associated with the request comprises an indication of at least one of a national context, a service segment context, a cell site context, or an incident context.

18. The system of claim 16, wherein the issue is associated with at least one of a network unavailability, a service segment unavailability, a cell site unavailability, or incidents in the telecommunications network.

19. The system of claim 16, wherein the initiating the action to resolve the issue in the telecommunication network comprises:
initiate a reset at a cell cite in the telecommunication network.

20. The system of claim 16, wherein the initiating the action to resolve the issue in the telecommunication network comprises:
create an incident ticket in an incident reporting system.
